(19) United States
(12) Patent Application Publication
(10) Pub. No.: US 2014/0149904 A1
(43) Pub. Date: May 29, 2014

(54) INFORMATION PROCESSING APPARATUS, METHOD FOR CONTROLLING THE SAME, AND STORAGE MEDIUM

(71) Applicant: CANON KABUSHIKI KAISHA, Tokyo (JP)

(72) Inventor: Tomonobu Hiraishi, Tokyo (JP)

(73) Assignee: CANON KABUSHIKI KAISHA, Tokyo (JP)

(21) Appl. No.: 14/088,907

(22) Filed: Nov. 25, 2013

(30) Foreign Application Priority Data
Nov. 26, 2012 (JP) 2012-257308

(51) Int. Cl. G06F 3/0482; G06F 3/0484

(52) U.S. Cl. CPC G06F 3/0482; G06F 3/0484
USPC 715/765

(57) ABSTRACT

An information processing apparatus displays a list of a plurality of objects on a display unit, and, if a first selection instruction to select one of the displayed objects is input, assigns layout order to the selected object. If a second selection instruction to collectively select a plurality of the displayed objects is input, the information processing apparatus assigns layout order to the selected plurality of objects in order continuous with the layout order already assigned to the object and based on a predetermined condition. According to the information processing apparatus, a user can assign specified desired order to each individual object while automatically and collectively assigning order to a plurality of objects based on the predetermined condition.

### BACKGROUND

1. Field of the Disclosure

Aspects of the present invention generally relates to a technique for selecting contents desired by a user in order.

2. Description of the Related Art

There are conventional information processing apparatuses that select a plurality of images, arrange the images in selected order, in order of captured date and time, or in file name order, and lay out and display the images on pages of an electronic book.

Conventionally, when a user arranges and lays out images in desired order, the user needs to select all the images in order one by one, which requires a lot of trouble. For example, suppose that the user wants to specify the order of some of the images, not all the images. Even in such a case, the user also needs to perform selection operations on the rest of the images in order one by one. Under the circumstances, when the user orders a plurality of contents, it is desired to be able to assign desired order to some of the contents by simple user operations.

### SUMMARY

According to an aspect of the present invention, an information processing apparatus includes a display unit configured to display a list of a plurality of objects, a first selection unit configured to input a first selection instruction to select one of the displayed objects, a second selection unit configured to input a second selection instruction to collectively select a plurality of the displayed objects, a first assignment unit configured to, if the first selection instruction is input, assign layout order to the object selected according to the first selection instruction, and a second assignment unit configured to, if the second selection instruction is input when the layout order has been assigned to the object by the first assignment unit, assign layout order to the plurality of objects selected according to the second selection instruction in order continuous with the layout order assigned to the object by the first assignment unit and based on a predetermined condition, wherein the information processing apparatus comprises a processor configured to execute a program stored in a memory to implement at least a part of the function of at least one of the units.

According to embodiments of the present invention, a user can assign specified desired order to each individual object while automatically and collectively assigning order to a plurality of objects based on a predetermined condition. This can reduce the user's trouble in making operations.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of an information processing apparatus according to a first exemplary embodiment.

FIG. 2 is a flowchart illustrating an operation of the information processing apparatus according to the first exemplary embodiment.

FIGS. 3A and 3B are diagrams illustrating examples of screens according to the first exemplary embodiment.

FIG. 4 is a diagram illustrating examples of a screen according to the first exemplary embodiment.

FIG. 5 is a diagram illustrating an example of an image information management table according to the first exemplary embodiment.

FIG. 6 is a flowchart illustrating an operation of the information processing apparatus according to the first exemplary embodiment.

FIG. 7 is a diagram illustrating an example of the screen according to the first exemplary embodiment.

FIG. 8 is a flowchart illustrating an operation of the information processing apparatus according to the first exemplary embodiment.

FIGS. 9A and 9B are diagrams illustrating examples of the screen according to the first exemplary embodiment.

FIG. 10 is a flowchart illustrating an operation of the information processing apparatus according to the first exemplary embodiment.

FIGS. 11A and 11B are diagrams illustrating examples of the screen according to the first exemplary embodiment.

FIG. 12 is a flowchart illustrating an operation of an information processing apparatus according to a second exemplary embodiment.

FIG. 13 is a flowchart illustrating an operation of the information processing apparatus according to the second exemplary embodiment.

### DESCRIPTION OF THE EMBODIMENTS

Various exemplary embodiments, features, and aspects of the invention will be described in detail below with reference to the drawings.

A first exemplary embodiment will be described below.

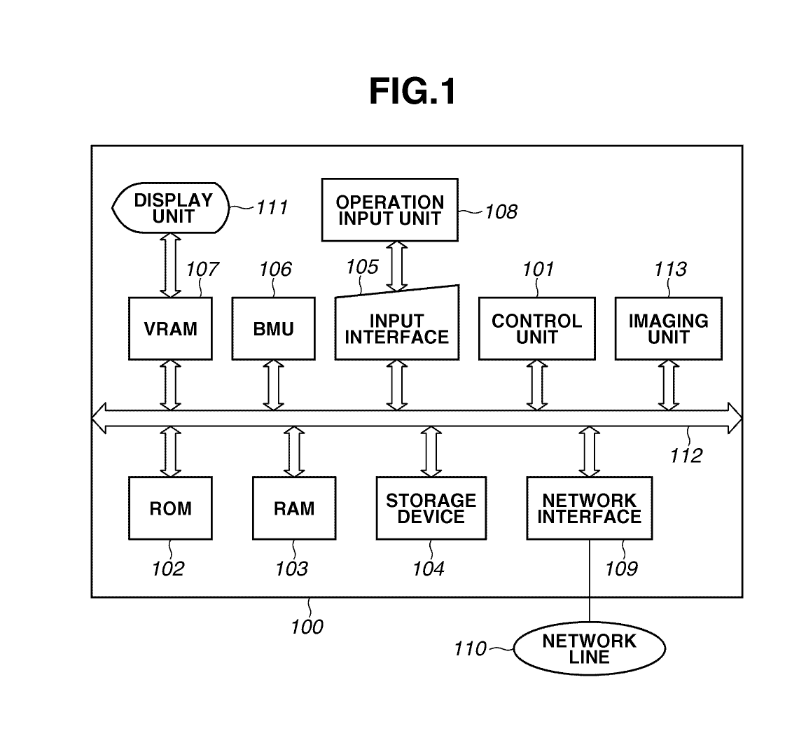

A configuration of an information processing apparatus according to the present exemplary embodiment will be described with reference to FIG. 1. The information processing apparatus may be implemented by a single computer apparatus. The information processing apparatus may be implemented by distributing functions to a plurality of computer apparatuses as needed. If a plurality of computer apparatuses is used, the computer apparatuses maybe connected for mutual communication by a communication line or lines such as a local area network (LAN).

In FIG. 1, a control unit 101 controls aspects of the information processing apparatus 100. An example of the control unit 101 is a central processing unit (CPU). A read-only memory (ROM) 102 stores a program(s) and a parameter(s) that need no change. A random access memory (RAM) 103 temporarily stores a program(s) and data that are supplied from an external device. A storage device 104 can be, for example, a hard disk or a memory card which is fixedly installed on the information processing apparatus 100. The storage device 104 stores a program(s) such as an operating system (OS). An input interface 105 is connected to an operation input unit 108 which receives a user's operation and inputs data. Examples of the operation input unit 108 include a pointing device, a keyboard, and a touch panel. A bit move unit (BMU) 106 controls data transfer, for example, between memories (for example, between a video RAM (VRAM) 107 and another memory) and between memories and I/O devices (for example, a network interface 109). The VRAM 107 draws images to be displayed on a display unit 111. The images generated by the VRAM 107 are transmitted to the display unit 111 according to predetermined specifications, and the display unit 111 displays the images. The network interface 109 connects to a network line 110 such as the Internet. An imaging unit 113 converts an optical image into an electrical signal to generate image data. The generated image data is stored in the storage device 104 such as a memory card. A system bus 112 connects the units 101 to 109 and 113 for communication.

The storage device 104 stores image layout application program software (hereinafter, referred to as an “image layout application”) according to the present exemplary embodiment. The storage device 104 also stores objects such as image files generated by an imaging apparatus, music files, and document files.

The present exemplary embodiment is not limited to the foregoing. The information processing apparatus 100 may be operated by keyboard operations. If the display unit 111 includes a touch panel including a touch sensor, the information processing apparatus 100 may be operated according to an output of the touch sensor.

The touch panel is an input device that is two-dimensionally configured and placed on the display unit 111 so that coordinate information according to a touched position is to be output.

If the operation input unit 108 is a touch panel, the control unit 101 can detect the following operations on the touch panel. That the touch panel is touched with a finger or pen (hereinafter, referred to as a touch-down). That the touch panel is being touched with a finger or pen (hereinafter, referred to as a touch-on). That a finger or pen touching the touch panel moves (hereinafter, referred to as a move). That a finger or pen having been touching the touch panel is released (hereinafter, referred to as a touch-up). That nothing is touching the touch panel (hereinafter, referred to as a touch-off).

In the present exemplary embodiment, a “tap” refers to an operation such that a touch-on is detected immediately after the detection of a touch-down, the touch-on continues being detected for a time shorter than a predetermined time, and no other touch operation is detected during a predetermined time before and after the detection of the touch-down.

Such operations and position coordinates where a finger or pen is touching on the touch panel are notified to the control unit 101. Based on the notified information, the control unit 101 determines what operation has been made on the touch panel. As for a move, the control unit 101 can determine the moving direction of the finger or pen moving on the touch panel both in terms of vertical and horizontal components on the touch panel based on a change in the position coordinates. If a touch-down made on the touch panel is followed by a move of more than a predetermined distance and a touch-up, the control unit 101 determines that dragging and then dropping (drag and drop) have been made. The touch panel may be any one of touch panels of various methods including a resistive film method, a capacitive method, a surface acoustic wave method, an infrared method, an electromagnetic induction method, an image recognition method, and an optical sensor method.

The present exemplary embodiment deals with a case where a smartphone is used as an example of the computer apparatus implementing the information processing apparatus 100. However, this is not restrictive. An exemplary embodiment of the present invention is applicable to an imaging apparatus such as a digital camera. More specifically, the exemplary embodiment of the present invention may be applied to when captured images recorded on a memory card or other recording medium readable by a digital camera are reproduced and displayed on a display such as a rear liquid crystal unit of the digital camera. The exemplary embodiment of the present invention may also be applied to apparatuses that can display images, text, and/or graphics images. Examples include a personal digital assistant (PDA), a mobile phone terminal, a portable image viewer, a printer apparatus including a display, an electronic photo frame, a music player, a game machine, and an electronic book reader.

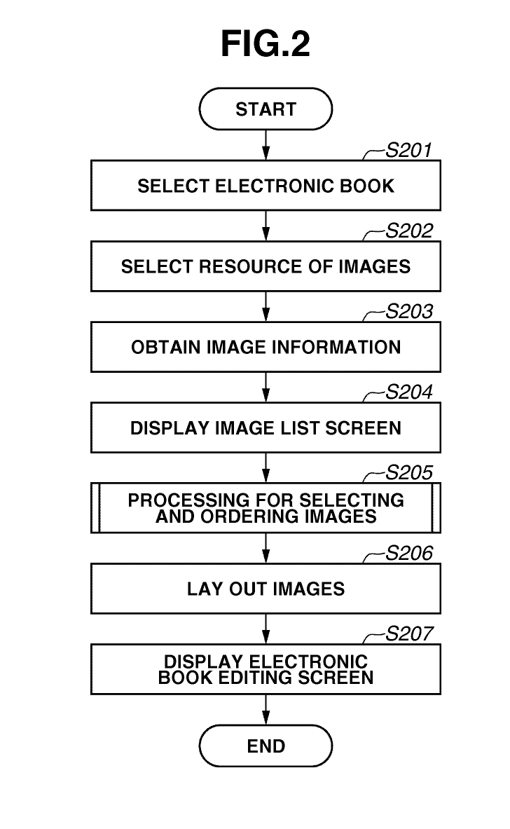

Processing by which the information processing apparatus 100 according to the present exemplary embodiment lays out a plurality of images on pages of an electronic book in selected order will be described with reference to FIG. 2. To implement the following processing, the control unit 101 of the information processing apparatus 100 reads the image layout application from the storage device 104 and controls the foregoing modules according to the image layout application.

In step S201, the control unit 101 selects an electronic book to be edited in response to a user's operation, and obtains a book identifier (ID) uniquely identifying the electronic book. In step S201, if an edited electronic book already stored in the storage device 104 is selected, the control unit 101 reads the book ID of the electronic book from the storage device 104. If a new electronic book is selected, the control unit 101 generates a new book ID.

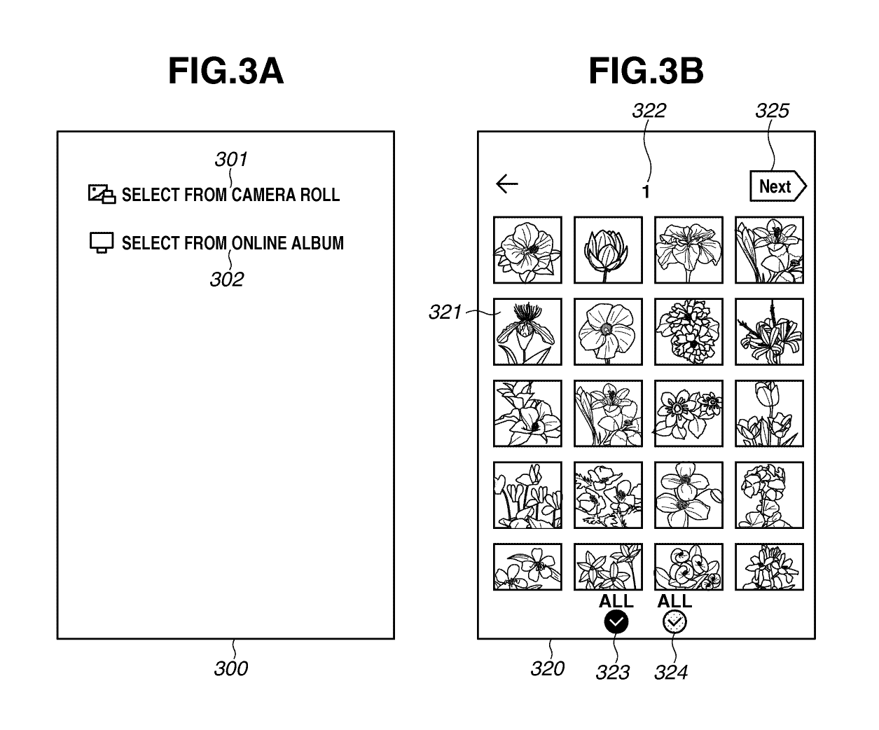

In step S202, the control unit 101 selects a resource of images to be laid out on the pages of the electronic book. Specifically, the control unit 101 displays a resource selection screen 300 for selecting a resource. FIG. 3A illustrates the resource selection screen 300, which displays buttons 301 and 302. The button 301 is intended to select images that are obtained by imaging processing of the imaging unit 113 of the information processing apparatus 100 and stored in the storage device 104. The button 302 is intended to select images that are stored in a storage on the Internet and downloadable via the network interface 109 of the information processing apparatus 100. The control unit 101 detects that the user has tapped either one of the buttons 301 and 302, and selects the resource corresponding to the tapped button 301 or 302.

In step S203, the control unit 101 obtains image information from the resource selected in step S201. If the control unit 101 detects that the user has tapped the button 301, the control unit 101 obtains image information including thumbnail images and file names of the respective stored images from the storage device 104. If the control unit 101 detects that the user has tapped the button 302, the control unit 101 accesses the storage on the Internet via the network interface 109 and obtains image information including thumbnail images and file names of the stored images.

In step S204, the control unit 101 generates display data on an image list screen according to the image information obtained in step S202, and performs display control to display the display data on the display unit 111. FIG. 3B illustrates an image list screen 320, which displays thumbnail images 321 and the number of selected images 322. The image list screen 320 also displays a “select all” button 323 for selecting all the images, a “cancel all” button 324 for deselecting all the images, and a “next” button 325 for ending image selection processing. To display thumbnail images of more images regardless of the orientations of the images, the image list screen 320 displays all the thumbnail images as trimmed to a square shape having an aspect ratio of 1:1.

In step S205, the control unit 101 performs processing for selecting and ordering images (image selection processing) in response to the user's operations. The processing performed in step S205 will be described in detail below.

In step S206, after the end of the image selection processing, the control unit 101 lays out the selected images on the pages of the electronic book according to the order assigned to the images, thereby generating display data on the electronic book. The display data is configured to successively display a plurality of pages included in the electronic book in a row.

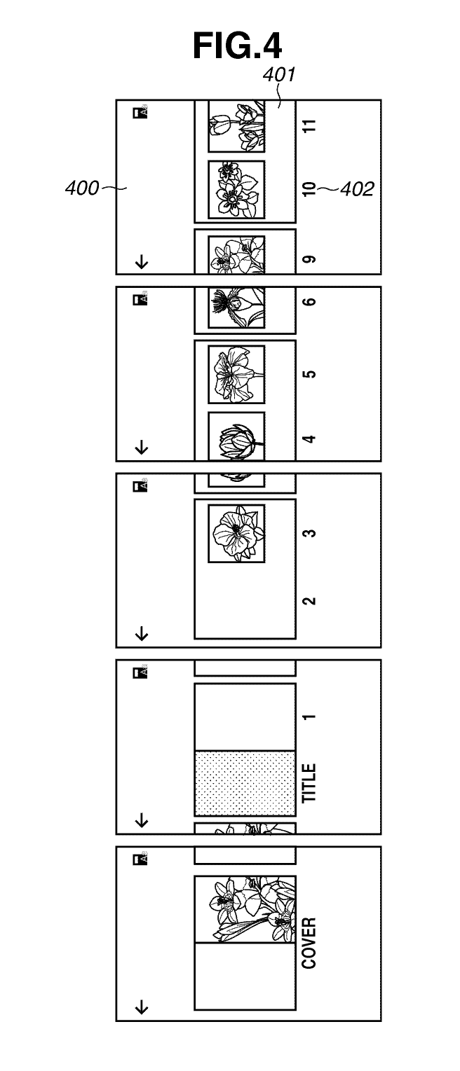

In step S207, the control unit 101 displays an electronic book editing screen 400 based on the display data generated in step S205. FIG. 4 illustrates the electronic book editing screen 400, which displays a part of the display data extracted according to a display size of a display area of the display unit 111. The control unit 101 switches the range of the display data displayed on the display area of the display unit 111 in response to the user's scroll operations on the display unit 111. In FIG. 4, images are laid out and displayed on some pages 401 corresponding to the scroll position among all the pages included in the electronic book. Page numbers 402 are also displayed.

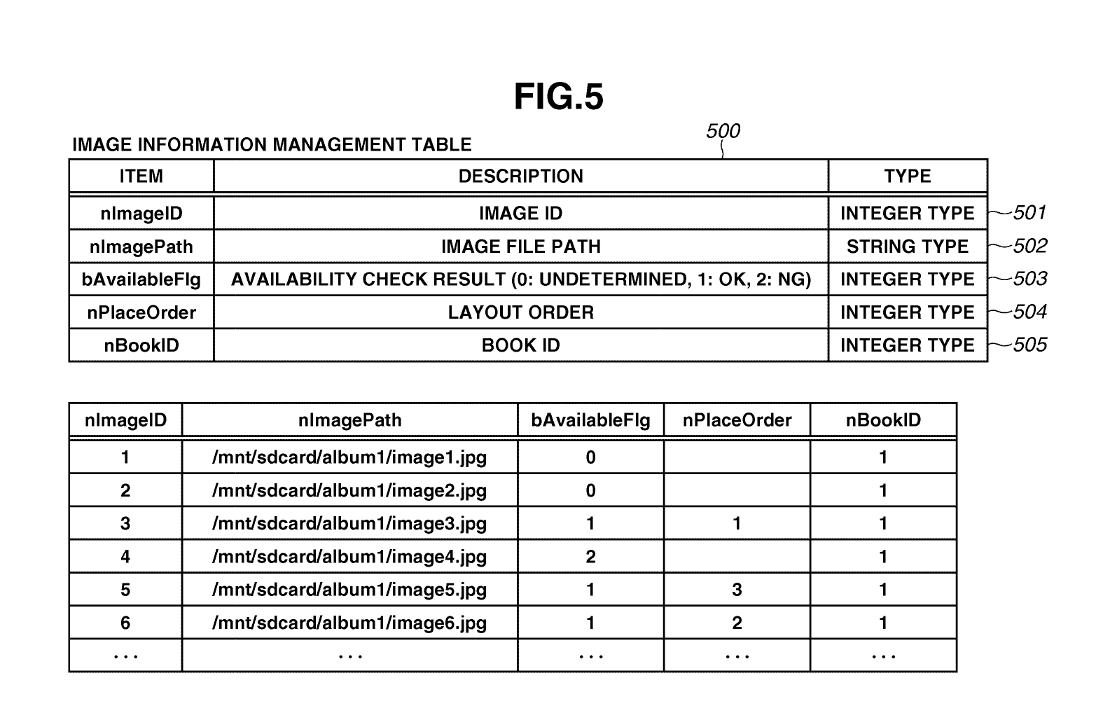

The thumbnail images 321 displayed on the image list screen 320 are stored in association with image IDs for uniquely identifying respective corresponding image files. The storage device 104 stores an image information management table which stores information about the images laid out on the pages of the electronic book by using the image IDs as keys. FIG. 5 illustrates an image information management table 500, which stores file paths 502 of image files, availability 503 to be described below, layout order 504, and a book ID(s) 505 of an electronic book(s) in which the images are laid out, in association with image IDs 501. If the resource of an image is the storage device 104, the file path 502 stores the file path of the image. If the resource is the storage on the Internet, the file path 502 stores the universal resource locator (URL) of the image.

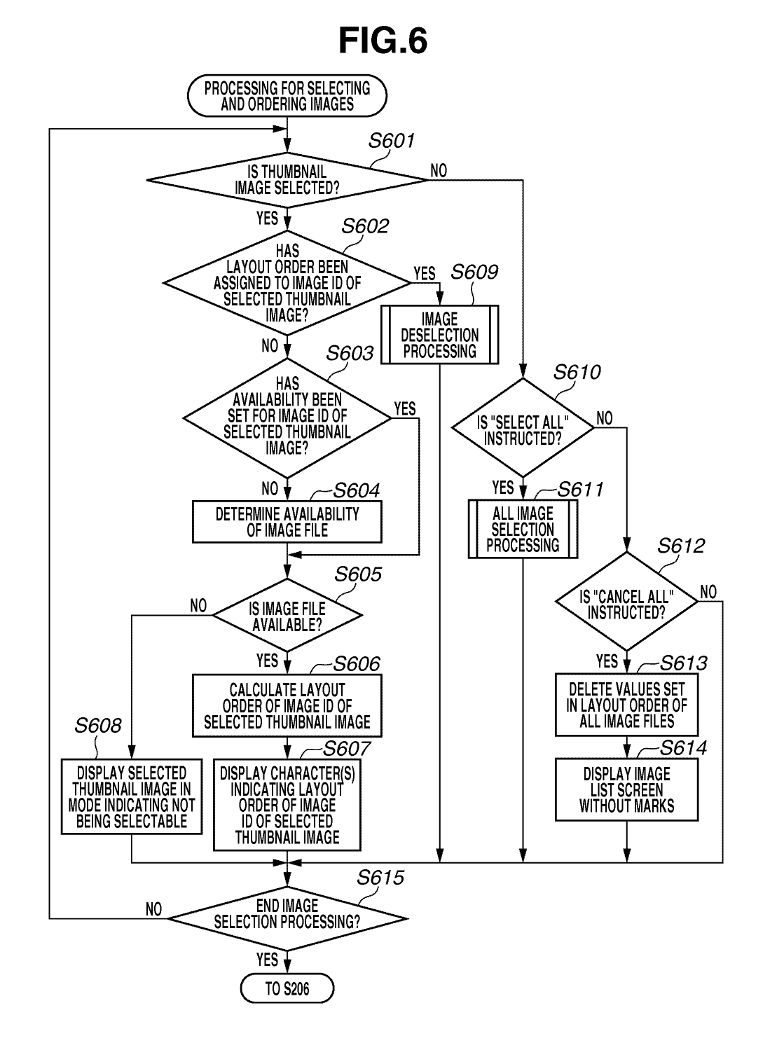

Next, the processing for selecting and ordering images in step S205 will be described in detail with reference to FIG. 6.

In step S601, the control unit 101 detects a tap operation on a thumbnail image displayed on the image list screen 320 and determines whether the thumbnail image is selected. If the thumbnail image is selected (YES in step S601), then in step S602, the control unit 101 refers to the image information management table 500 stored in the storage device 104 and determines whether layout order has been assigned to the image ID of the thumbnail image selected in step S601. In the present exemplary embodiment, if layout order has already been assigned, a numeral indicating the layout order is stored in the layout order 504. If no layout order has been assigned, the layout order 504 remains blank.

If no layout order has been assigned to the image ID of the thumbnail image (NO in step S602), then in step S603, the control unit 101 refers to the image information management table 500 and determines whether availability has been set for the image ID of the thumbnail image selected in step S601.

If no availability is determined to have been set for the image ID of the thumbnail image (NO in step S603), the control unit 101 refers to the image information management table 500 and obtains an image file based on the file path associated with the image ID. In step S604, the control unit 101 determines availability, and stores the determination result in the availability 503 of the image information management table 500. For example, the control unit 101 compares vertical and horizontal sizes and a file size of the image file with predetermined ranges, and determines the availability based on whether the comparison result satisfies a predetermined condition. In the present exemplary embodiment, possible values of the availability 503 include “0” which is an initial value and indicates that no determination has been made, “1” which indicates that the image file is determined to be available (OK), and “2” which indicates that the image file is not available (NG).

In step S605, the control unit 101 refers to the availability 503 of the image information management table 500 and determines whether the image file corresponding to the thumbnail image selected in step S601 is available.

If the image file is available (YES in step S605), the control unit 101 refers to the image information management table 500 to obtain a maximum value of the layout order associated with the book ID obtained in step S201. In step S606, the control unit 101 adds “1” to the maximum value to calculate the layout order of the image ID of the thumbnail image selected in step S601. The control unit 101 stores the calculated layout order into the image information management table 500 in association with the image ID of the thumbnail image selected in step S601.

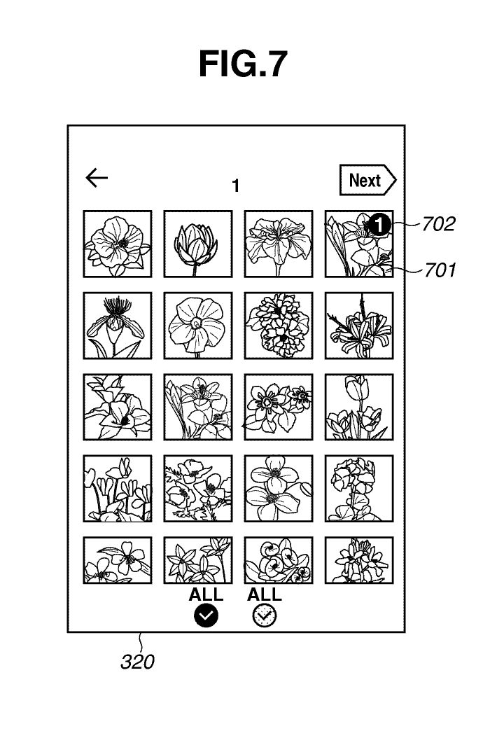

In step S607, the control unit 101 draws a character or characters indicating the layout order calculated in step S606 as superimposed on the thumbnail image selected in step S601, and displays the resultant on the display unit 111. As illustrated in FIG. 7, a mark 702 is displayed as superimposed on a thumbnail image 701 on the image list screen 320. The mark 702 indicates that the image to be selected is the first in the layout order. The character(s) indicating the layout order may be displayed near the thumbnail image, not necessarily on the thumbnail image, as long as the character(s) can be easily recognized by the user.

If the image file is not available (NO in step S605), then in step S608, the control unit 101 identifiably draws the thumbnail image selected in step S601 in a mode indicating that the thumbnail is not selectable, and displays the resultant on the display unit 111. Examples of the mode indicating not being selectable include displaying the thumbnail image with a transparency higher than normal display, displaying the thumbnail image with a diagonal line superimposed thereon, graying out the thumbnail image, and hiding the thumbnail image. As a result, the user can intuitively recognize that the image is not available. This can prevent the user from selecting the unavailable image repeatedly.

In step S602, if layout order has been set to the image ID of the thumbnail image (YES in step S602), then in step S609, the control unit 101 performs image deselection processing to be described below. In step S601, if the thumbnail image is not selected (NO in step S601), then in step S610, the control unit 101 determines whether “select all” is instructed. If “select all” is instructed (YES in step S610), then in step S611, the control unit 101 performs all image selection processing to be described below. If “select all” is not instructed (NO in step S610), then in step S612, the control unit 101 determines whether “cancel all” is instructed.

If “cancel all” is instructed (YES in step S612), then in step S613, the control unit 101 selects all the image files existing in the resource selected in step S201, and deletes all the values set in the layout order 504 of the image information management table 500. Here, the control unit 101 does not delete the values set in the availability 503 of the image information management table 500. Consequently, when the same thumbnail images are selected again, the control unit 101 can reuse the determination results about the availability without repeating the processing for determining the availability. In step S614, the control unit 101 displays the image list screen 320 without marks indicating layout order on the display unit 111 like the one initially displayed as illustrated in FIG. 3B.

In step S615, the control unit 101 detects the user's predetermined operation and determines whether to end the image selection processing. If no end instruction has been given (NO in step S615), the control unit 101 returns to the processing of step S601. If an end instruction has been given (YES in step S615), the control unit 101 ends the processing. An example of the predetermined processing is a pressing operation on the “next” button 325.

In the present exemplary embodiment, an operation such that the control unit 101 detects a touch-on immediately after the detection of a touch-down, continues detecting the touch-on for less than a predetermined time, and detects no other touch operation within a predetermined time before and after the detection of the touch-down will be referred to as a “single tap.” An operation such that the control unit 101 continues detecting the touch-on for more than a predetermined time and detects no other touch operation within a predetermined time before and after the touch-down will be referred to as a “long tap.” In step S601, if the control unit 101 detects a single tap, the control unit 101 determines that the thumbnail image is selected as an object to be laid out on the electronic book. On the other hand, if the control unit 101 detects a long tap, the control unit 101 enlarges the image corresponding to the thumbnail image. In such a manner, the user can easily switch between the operation of selecting an image as an object to be laid out on the electronic book and the operation of checking details of the image. This provides improved usability.

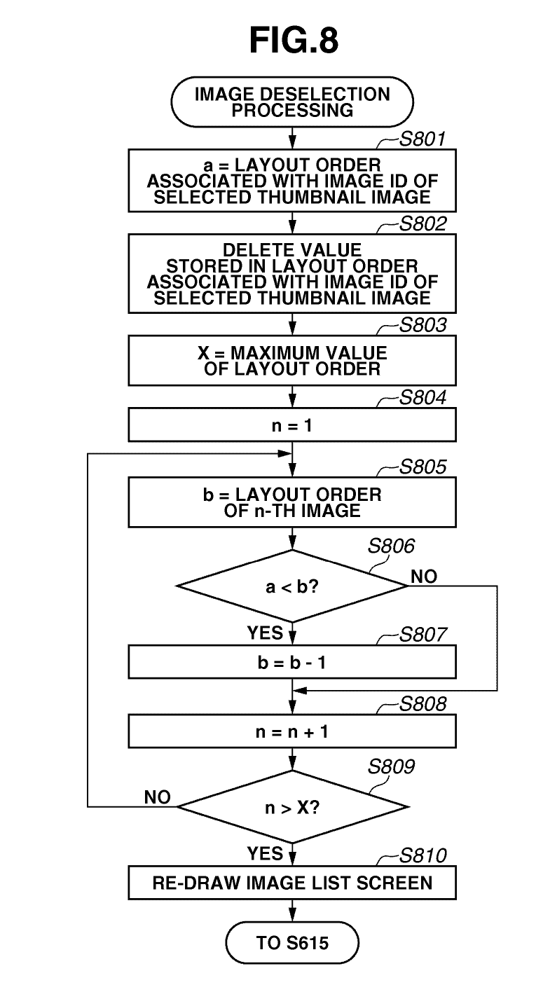

Next, the image deselection processing of step S609 will be described with reference to the flowchart of FIG. 8.

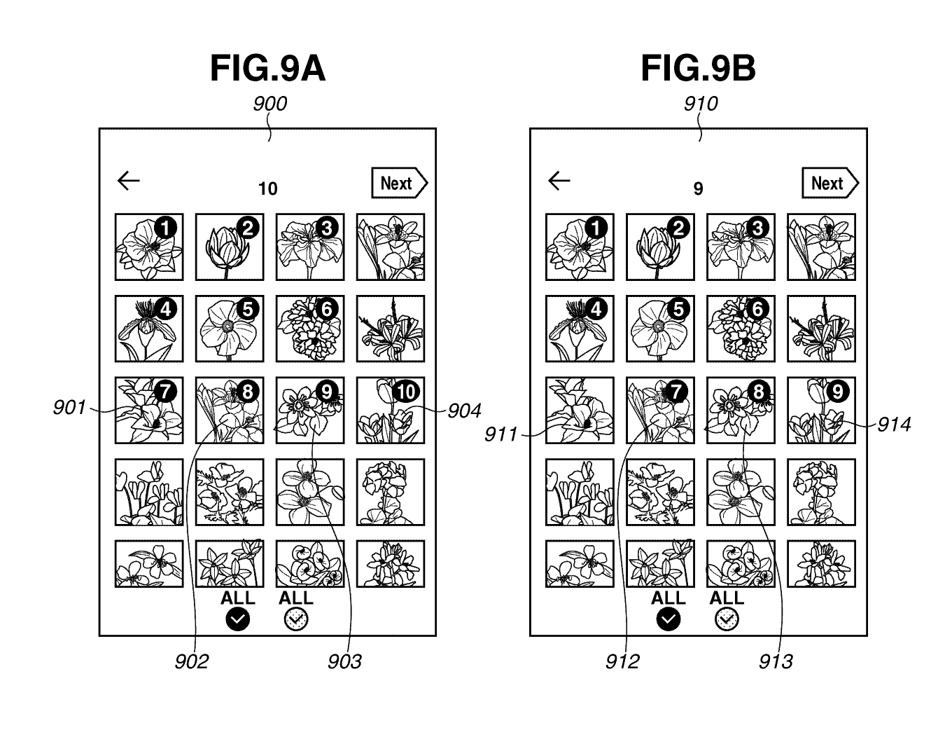

In step S801, the control unit 101 refers to the image information management table 500 to obtain the layout order 504 associated with the image ID of the thumbnail image selected in step S601, and substitutes the layout order 504 into a variable a. For example, suppose that in step S601, the user selects a mark-superimposed thumbnail image 901 displayed on an image list screen 900 illustrated in FIG. 9A by a tap operation. In such a case, the control unit 107 substitutes “7” into the variable a.

In step S802, the control unit 101 deletes the value stored in the layout order 504 associated with the image ID of the thumbnail image selected in step S601. The image selected in step S601 is thereby excluded from the objects to be arranged on the electronic book. Here, the control unit 101 does not delete the value stored in the availability 503 associated with the image ID of the thumbnail image selected in step S601. Consequently, when the same thumbnail image is selected again, the control unit 101 can reuse the determination result about the availability without repeating the processing for determining the availability.

In step S803, the control unit 101 refers to the image information management table 500 to obtain a maximum value of the layout order 504, and substitutes the maximum value into a variable X. In the case of the image list screen 900 of FIG. 9A, the control unit 101 substitutes “10” into the variable X. In step S804, the control unit 101 substitutes “1” into a variable n as an initial value. In step S805, the control unit 101 obtains the layout order 504 of the n-th image when the images having any value stored in their layout order 504 are arranged based on a predetermined condition. The control unit 101 substitutes the obtained layout order 504 into a variable b. Examples of the predetermined condition include ascending or descending order of the creation date and time of the image files, ascending or descending order of the file names, ascending or descending order of evaluations given to the image files, and arbitrary order calculated by a predetermined algorithm. In the image list screen 900, the thumbnail images are arranged in order based on a predetermined condition and displayed on the display unit 111.

In step S806, the control unit 101 compares the variables a and b to determine whether the variable a is smaller than the variable b. In other words, the control unit 101 determines whether the n-th image has been laid out after the image selected in step S601 in order. In the image list screen 900 of FIG. 9A, thumbnail images 902 to 904 are arranged after the thumbnail image 901.

If the variable a is smaller than the variable b (YES in step S806), the control unit 101 subtracts “1” from the variable b to calculate the layout order of the n-th image. The control unit 101 updates the value of the layout order 504 of the n-th image with the calculation. Since the image selected in step S601 is excluded from the objects to be laid out on the electronic book, the images laid out after the image selected in step S601 are thus advanced by one in the layout order.

In step S808, the control unit 101 adds “1” to the variable n. In step S809, the control unit 101 compares the variables n and X to determine whether the variable n is greater than the variable X. If the variable n is greater than the variable X (YES in step S809), then in step S810, the control unit 101 updates the marks 702 on the image list screen 320 and draws the marks 702 as superimposed on the corresponding thumbnail images based on the layout order 504 of the image information management table 500. The control unit 101 displays the resultant on the display unit 111. In the case of an image list screen 910 illustrated in FIG. 9B, the marks indicating the layout order of the thumbnail images 912 to 914 are updated and displayed. The mark indicating the layout order of the thumbnail image 911 is deleted.

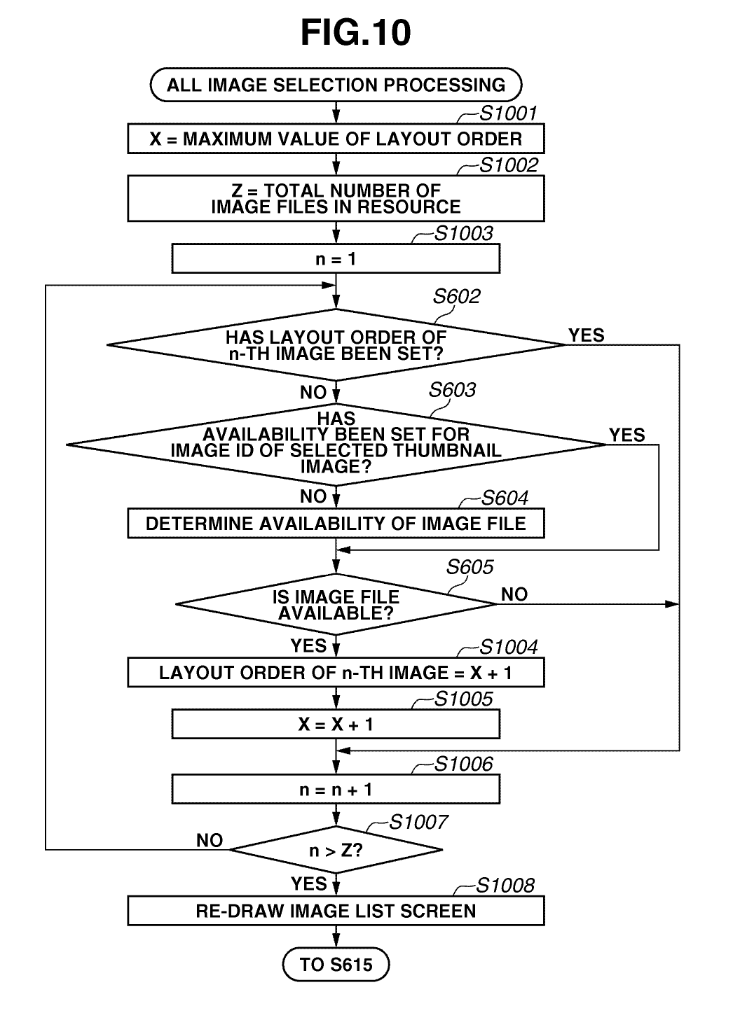

Next, the all image selection processing of step S611 will be described with reference to the flowchart of FIG. 10. When an instruction to select all is input, the control unit 101 of the information processing apparatus 100 selects all the image files existing in the resource selected in step S201 as objects to be set layout order.

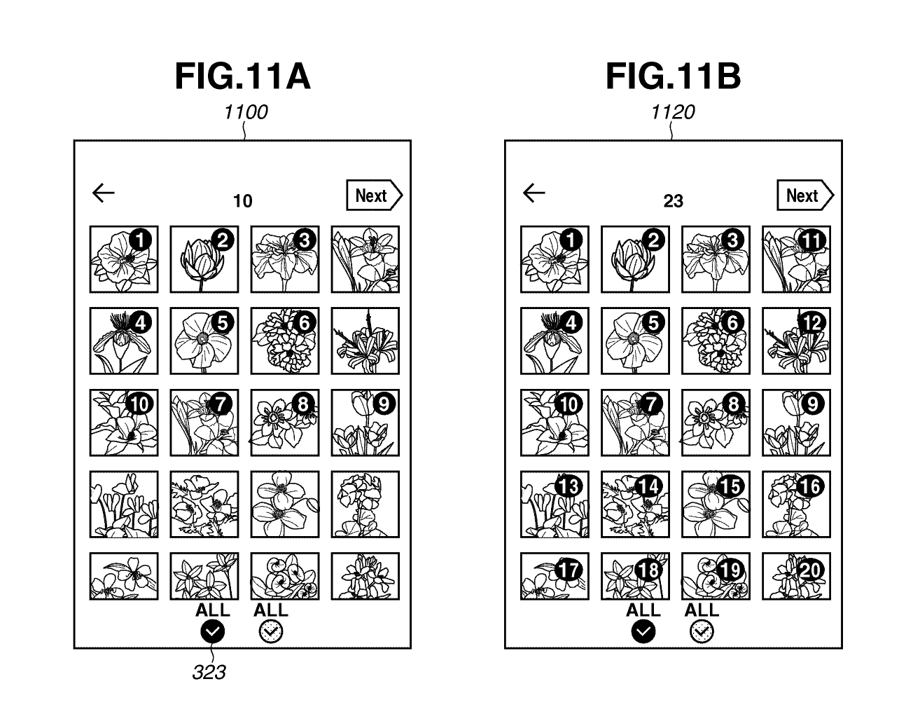

In step S1001, the control unit 101 refers to the image information management table 500 to obtain the maximum value of the layout order 504, and substitutes the maximum value into the variable X. In the case of an image list screen 1100 illustrated in FIG. 11A, the control unit 101 substitutes “10” into the variable X.

In step S1002, the control unit 101 obtains the total number of image files existing in the resource selected in step S201, and substitutes the total number into a variable Z. In step S1003, the control unit 1001 substitutes “1” into the variable n as an initial value.

The control unit 101 performs similar processing to that of the foregoing steps S602 to S605. In step S602, if the layout order is determined to have been set (YES in step S602), the control unit 101 performs the processing of step S1006. In other words, if the layout order of the image has been set when the instruction to select all is input, processing for setting new layout order is skipped. The existing layout order is maintained without being reset.

In step S605, if the image file is determined to be available (YES in step S605), then in step S1004, the control unit 101 sets a value determined by adding “1” to the variable X to the layout order 504 of the n-th image. In such a manner, the control unit 101 sets layout order to the rest of the images to which no layout order has been set by user operations, so that the layout order is continuous with that already set to the other images. In step S1005, the control unit 101 adds “1” to the variable X.

If the layout order of the n-th image has been set (YES in step S602), the processing proceeds to step S1006 without the control unit 101 updating the layout order of the n-th image. This can maintain the desired order that the user has assigned to images by making a single tap operation one by one.

In step S1006, the control unit 1001 adds “1” to the variable n. In step S1007, the control unit 1001 compares the variables n and Z to determine whether the variable n is greater than the variable Z. If the variable n is greater than the variable Z (YES in step S1007), then in step S1008, the control unit 101 draws marks indicating the assigned new layout order as superimposed on the thumbnail images on the image list screen 320 based on the layout order 504 of the image information management table 500, and displays the resultant on the display unit 111. FIG. 11B illustrates an image list screen 1120, where marks indicating the layout order are displayed as superimposed on all the thumbnail images. The marks to be superimposed on the thumbnail images of the images to which the layout order has been set before “select all” is instructed are superimposed and displayed without change.

As described above, in the present exemplary embodiment, if an instruction to select all is input, the control unit 101 selects all the image files existing in the resource selected in step S201. The control unit 101 does not change but maintain the layout order of images that have already been selected and to which the layout order has been set by tap operations. This maintains the layout order set to the images intended and selected by the user. As for images that the user has not selected in particular and to which no layout order has been set, layout order is automatically set.

The present exemplary embodiment has dealt with the case where the user selects images by single tap operations and the control unit 101 arranges the remaining images after the layout order of the selected images and sets the subsequent numbers as layout order. However, the control unit 101 may arrange the images selected by single tap operations after the remaining images. In such a case, if “select all” is instructed (YES in step S610), the control unit 101 selects whether to arrange the images selected by single tap operations before or after the remaining images. If the selected images are to be arranged before the remaining images, the control unit 101 performs the processing of the foregoing step S611. If the selected images are to be arranged after the remaining images, the control unit 101 updates the layout order by adding the total number of remaining images to the layout order 504 set to the images selected by the single tap operations. The control unit 101 then sets consecutive numbers staring at “1” to the remaining images in arranged order based on a predetermined condition.

A second exemplary embodiment will be described below.

The first exemplary embodiment has dealt with the case where, when the user selects an image by a single tap, the control unit 101 sets the layout order of the image in selected order. The present exemplary embodiment deals with a case where, when the user selects an image by a single tap, the control unit 101 sets a value desired by the user as the layout order. The following description does not repeat the configuration common to the first exemplary embodiment. A configuration unique to the present exemplary embodiment is described in detail.

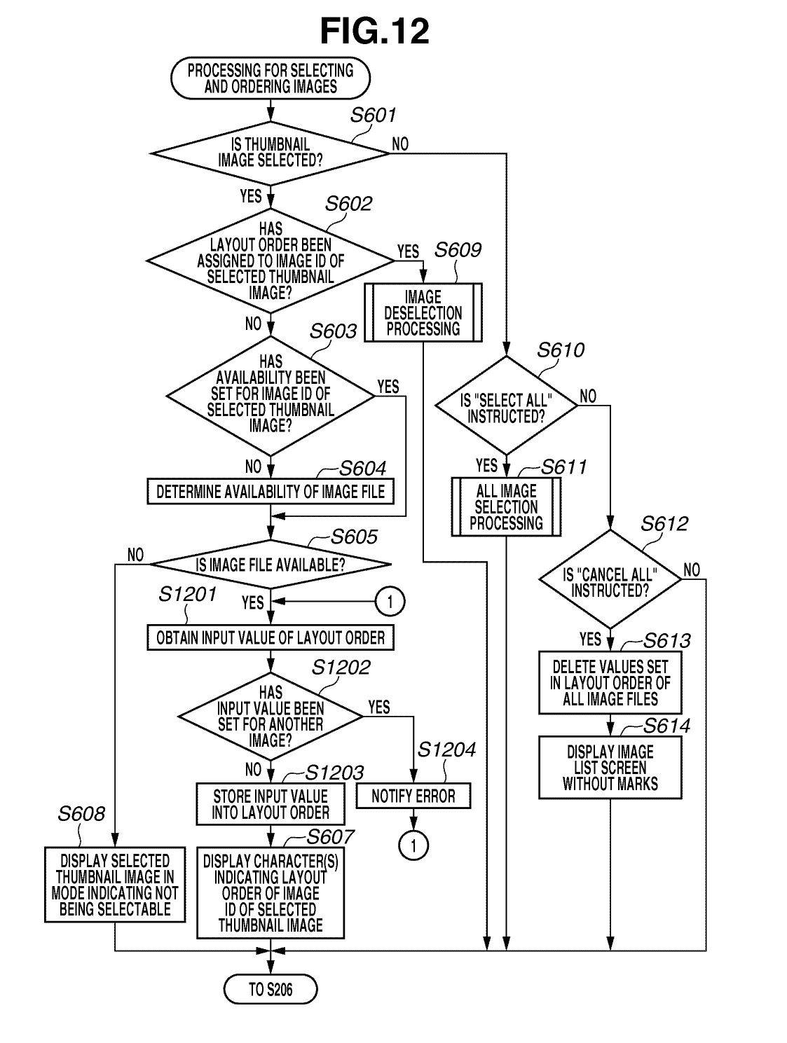

The processing for selecting and ordering images which the information processing apparatus 100 according to the present exemplary embodiment performs in step S205 will be described below with reference to FIG. 12. The control unit 101 initially performs the same processing as that of step S601 to S605.

If the image file is available (YES in step S605), then in step S1201, the control unit 101 obtains a value of layout order input in response to the user's operation. In step S1202, the control unit 101 refers to the image information management table 500 and determines whether the value of the layout order input in step S1201 has already been set to another image. If the input value of the layout order has not been set to another image (NO in step S1202), then in step S1203, the control unit 101 stores the value obtained in step S1201 in the layout order 504 in association with the image ID of the thumbnail image selected in step S601. In step S607, the control unit 101 draws a character or characters indicating the layout order set in step S1203 as superimposed on the thumbnail image selected in step S601, and displays the resultant on the display unit 111.

The present exemplary embodiment has dealt with the case where the user inputs a value each time the user selects an image in step S1201. However, this is not restrictive. For example, the user may initially input a start number, and the control unit 101 may set layout order starting at the start number to selected images in selected order until the user gives a predetermined instruction.

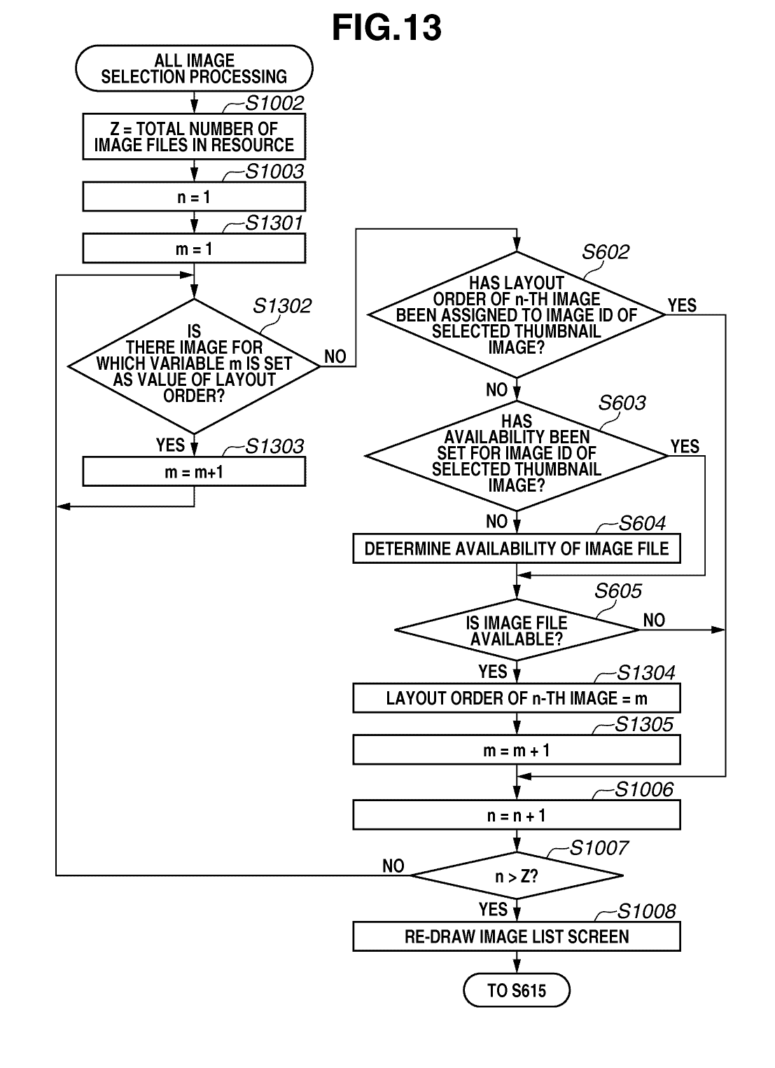

The all image selection processing which the information processing apparatus 100 according to the present exemplary embodiment performs in step S611 will be described below with reference to FIG. 13. In the present exemplary embodiment, the control unit 101 assigns unassigned numbers other than the layout order having been assigned to the images selected in response to the user's operations to unselected images in order based on a predetermined condition. The control unit 101 initially performs the same processing as that of steps S1002 and S1003 in the flowchart of FIG. 10 described above.

In step S1301, the control unit 101 substitutes “1” into a variable m as an initial value. In step S1302, the control unit 101 refers to the image information management table 500 and determines whether there is an image to which the variable m is set as the value of the layout order 504. If the variable m is set as the layout order 504 (YES in step S1302), then in step S1303, the control unit 101 adds “1” to the variable m. The control unit 101 then performs the processing of step S1302. If the variable m is not set as the layout order 504 (NO in step S1302), the control unit 101 performs the processing of steps S602 to S605 in FIG. 6.

If the image file is available (YES in step S605), then in step S1304, the control unit 101 sets the variable m to the layout order 504 of the n-th image. The control unit 101 then performs the processing of steps S1006 to S1008 in FIG. 10.

As described above, in the present exemplary embodiment, the user assigns arbitrary numbers to desired images by the processing illustrated in the flowchart of FIG. 12. The control unit 101 then performs the processing illustrated in the flowchart of FIG. 13 to assign unassigned numbers to the remaining images in order. In such a manner, continuous order can be assigned to the images.

The foregoing first and second exemplary embodiments have dealt with the cases where the all image selection processing selects all the images existing in the resource. However, this is not restrictive. For example, an upper limit may be set in advance to the number of images that can be used on an electronic book. In such a case, the control unit 101 may automatically extract images other than those selected in response to the user's tap operations so that the total number of images coincides with the upper limit, and perform the foregoing processing.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and function.

This application claims the benefit of Japanese Patent Application No. 2012-257308 filed Nov. 26, 2012, which is hereby incorporated by reference herein in its entirety.

What is claimed is:

1. An information processing apparatus comprising:
a display unit configured to display a list of a plurality of objects;
a first selection unit configured to input a first selection instruction to select one of the displayed objects;
a second selection unit configured to input a second selection instruction to collectively select a plurality of the displayed objects;
a first assignment unit configured to, if the first selection instruction is input, assign layout order to the object selected according to the first selection instruction; and
a second assignment unit configured to, if the second selection instruction is input when the layout order has been assigned to the object by the first assignment unit, assign layout order to the plurality of objects selected according to the second selection instruction in order continuous with the layout order assigned to the object by the first assignment unit and based on a predetermined condition,
wherein the information processing apparatus comprises a processor configured to execute a program stored in a memory to implement at least a part of the function of at least one of the units.

2. The information processing apparatus according to claim 1, wherein the second selection instruction is to collectively select a plurality of objects including the object to which the layout order has been assigned by the first assignment unit, and
wherein the second assignment unit is configured to assign the layout order to the objects selected according to the second selection instruction except the object to which the layout order has been assigned by the first assignment unit, in order continuous with the layout order assigned to the object by the first assignment unit and based on the predetermined condition.

3. The information processing apparatus according to claim 1, further comprising a deletion unit configured to, if the first selection instruction to select a object to which the layout order has been assigned is input, delete the layout order assigned to the selected object.

4. The information processing apparatus according to claim 1, further comprising:
a deselection unit configured to input a deselection instruction to collectively deselect all the displayed objects; and
a deletion unit configured to, if the deselection instruction is input, delete the layout order assigned to all the objects.

5. The information processing apparatus according to claim 1, further comprising a determination unit configured to determine availability of at least one of the objects before one of the first and second assignment units assigns the layout order,
wherein one of the first and second assignment units is configured not to assign the layout order to an object of which a determination result indicates that the object is unavailable.

6. The information processing apparatus according to claim 5, further comprising a display control unit configured to perform control to display the list of the plurality of objects on the display unit so that the object of which the determination result indicates that the object is unavailable is identifiable.

7. The information processing apparatus according to claim 5, further comprising a storage unit configured to store information in association with the object, the information indicating that the determination result indicates that the object is unavailable.

8. The information processing apparatus according to claim 1, further comprising a layout unit configured to arrange at least one of the objects in order according to the layout order assigned to the at least one of the objects by one of the first and second assignment units and to lay out the at least one of the objects on a at least one page of an electronic book.

9. The information processing apparatus according to claim 1, wherein the second assignment unit is configured to assign values continuous with the layout order assigned to the object by the first assignment unit as the layout order of the objects to which no layout order has been assigned by the first assignment unit, in at least one of ascending or descending order of generation date and time of the objects, ascending or descending order of file names of the objects, descending or ascending order of evaluations given to the objects, and arbitrary order based on a predetermined algorithm.

10. The information processing apparatus according to claim 1, wherein the first assignment unit is configured to assign the layout order to the selected object in order of selection according to the first selection instruction.

11. The information processing apparatus according to claim 1, wherein the first assignment unit is configured to assign layout order input in response to a user's operation to the selected object.

12. A method for controlling an information processing apparatus, the method comprising:
controlling to display a list of a plurality of objects;
inputting a first selection instruction to select one of the displayed objects;
inputting a second selection instruction to collectively select a plurality of objects of the displayed objects;
assigning, if the first selection instruction is input, layout order to the object selected according to the first selection instruction; and
assigning, if the second selection instruction is input when the layout order has been assigned to the object, layout order to the plurality of objects selected according to the second selection instruction in order continuous with the layout order assigned to the object and based on a predetermined condition.

13. A computer-readable storage medium storing a program implementing an information processing apparatus comprising:
controlling to display a list of a plurality of objects;
inputting a first selection instruction to select one of the displayed objects;
inputting a second selection instruction to collectively select a plurality of objects of the displayed objects;
assigning, if the first selection instruction is input, layout order to the object selected according to the first selection instruction; and
assigning, if the second selection instruction is input when the layout order has been assigned to the object, layout order to the plurality of objects selected according to the second selection instruction in order continuous with the layout order assigned to the object and based on a predetermined condition.
